(19) United States
(12) Patent Application Publication
(10) Pub. No.: US 2005/0152148 A1
(43) Pub. Date: Jul. 14, 2005

(54) Lamp shade

(76) Inventor: Kevin Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/755,887

(22) Filed: Jan. 12, 2004

(51) Int. Cl. F21V 11/00

(52) U.S. Cl. 362/351

(57) ABSTRACT

A lamp shade includes a shade provided with a first ring and a second ring, and a support structure mounted in the shade and located between the first ring and the second ring. The support structure includes a main frame mounted between the first ring and the second ring, and a plurality of support bars mounted between the first ring and the second ring. Thus, the lamp shade can be folded when not in use, so as to reduce the volume of the lamp shade, thereby facilitating package, storage and transportation of the lamp shade, and thereby decreasing the costs of package and transportation.

### BACKGROUND OF THE INVENTION

1. Field of the Invention

The present invention relates to a lamp shade, and more particularly to a lamp shade that can be folded when not in use, so as to reduce the volume of the lamp shade, thereby facilitating package, storage and transportation of the lamp shade.

2. Description of the Related Art

A conventional support structure 1 for a lamp shade in accordance with the prior art shown in FIG. 8 is mounted in the lamp shade and comprises an upper ring 11, a lower ring 12, and a plurality of ribs 13 mounted between the upper ring 11 and the lower ring 12. The upper ring 11 has a mounting rack 111 for mounting a lamp, such as a table lamp.

However, the ribs 13 are fixed between the upper ring 11 and the lower ring 12 by soldering, so that the conventional support structure has a fixed volume and cannot be folded, thereby causing inconvenience in package, storage and transportation of the conventional support structure 1, and thereby increasing costs of package and transportation.

### SUMMARY OF THE INVENTION

The primary objective of the present invention is to provide a lamp shade that can be folded when not in use, so as to reduce the volume of the lamp shade, thereby facilitating package, storage and transportation of the lamp shade, and thereby decreasing the costs of package and transportation.

Another objective of the present invention is to provide a lamp shade that can be assembled and disassembled easily and conveniently, thereby facilitating the user assembling and disassembling the lamp shade.

In accordance with the present invention, there is provided a lamp shade, comprising:
a shade;
a first ring fixed on a first end of the shade;
a second ring fixed on a second end of the shade; and
a support structure mounted in the shade and located between the first ring and the second ring for supporting the shade, wherein:
the support structure includes a main frame mounted between the first ring and the second ring to stretch the shade, and a support portion mounted on the main frame.

Further benefits and advantages of the present invention will become apparent after a careful reading of the detailed description with appropriate reference to the accompanying drawings.

### BRIEF DESCRIPTION OF THE DRAWINGS

FIG. 1 is a partially plan cross-sectional view of a lamp shade in accordance with the preferred embodiment of the present invention;

FIG. 2 is a partially perspective view of the lamp shade in accordance with the preferred embodiment of the present invention;

FIG. 3 is a partially enlarged view of the lamp shade as shown in FIG. 2;

FIG. 4 is a partially enlarged view of the lamp shade as shown in FIG. 2;

FIG. 5 is a partially perspective view of the lamp shade in accordance with the preferred embodiment of the present invention;

FIG. 6 is a partially enlarged view of the lamp shade as shown in FIG. 5;

FIG. 7 is a partially perspective view showing the lamp shade being mounted on a table lamp; and

FIG. 8 is a perspective view of a conventional lamp shade in accordance with the prior art.

### DETAILED DESCRIPTION OF THE INVENTION

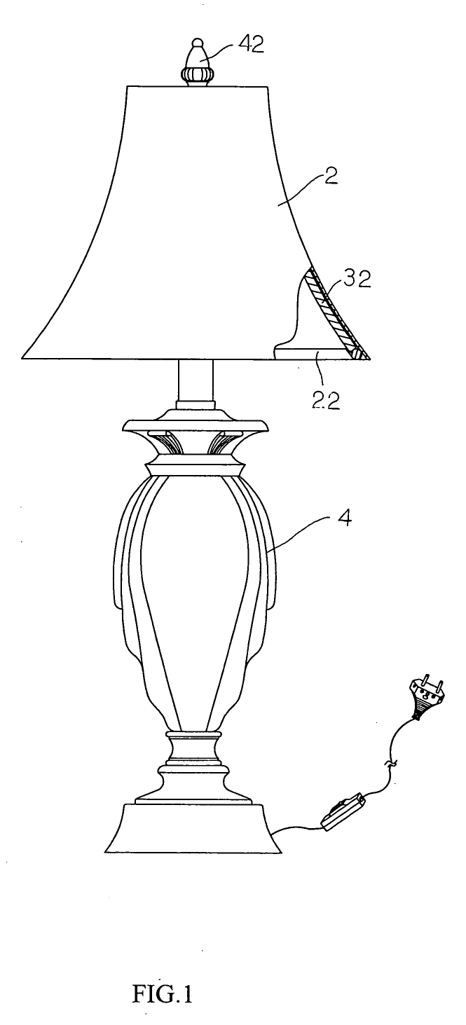

Referring to the drawings and initially to FIGS. 1-6, a lamp shade in accordance with the preferred embodiment of the present invention comprises a shade 2, a first ring 21 fixed on a first end of the shade 2, a second ring 22 fixed on a second end of the shade 2, and a support structure 3 mounted in the shade 2 and located between the first ring 21 and the second ring 22 for supporting the shade 2. The shade 2 is made of flexible material, such as cloth or the like. The second ring 22 has a periphery formed with a plurality of locking sockets 221.

The support structure 3 is foldable and includes a main frame 32 mounted between the first ring 21 and the second ring 22, and a ring-shaped support portion 31 mounted on the main frame 32 by soldering.

The main frame 32 is substantially inverted U-shaped and has a first portion formed with two bent urging portions 321 each urged on a periphery of the first ring 21 and a second portion formed with two locking ends 322 each locked in either one of the locking sockets 221 of the second ring 22. The support portion 31 has a periphery formed with a plurality of locking holes 311.

The support structure 3 further includes a plurality of substantially inverted L-shaped support bars 33 mounted between the first ring 21 and the second ring 22. Each of the support bars 33 has a bent urging portion 332 urged on the periphery of the first ring 21. Each of the support bars 33 has a first end formed with an insert 331 inserted into a respective one of the locking holes 311 of the support portion 31 and a second end formed with a locking end 333 locked in a respective one of the locking sockets 221 of the second ring 22.

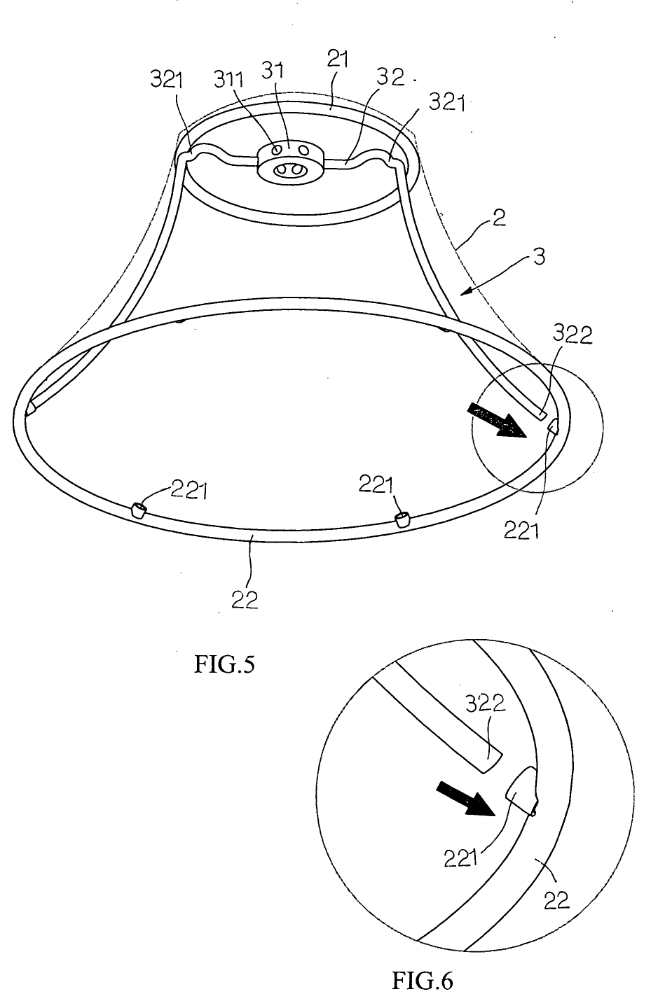

In assembly, referring to FIGS. 1-7, the main frame 32 is mounted between the first ring 21 and the second ring 22, with the bent urging portions 321 of the main frame 32 being urged on the periphery of the first ring 21, and with the locking ends 322 of the main frame 32 being locked in the locking sockets 221 of the second ring 22, so that the first ring 21 and the second ring 22 are supported by the main frame 32 so as to expand and stretch the shade 2 as shown in FIG. 5.

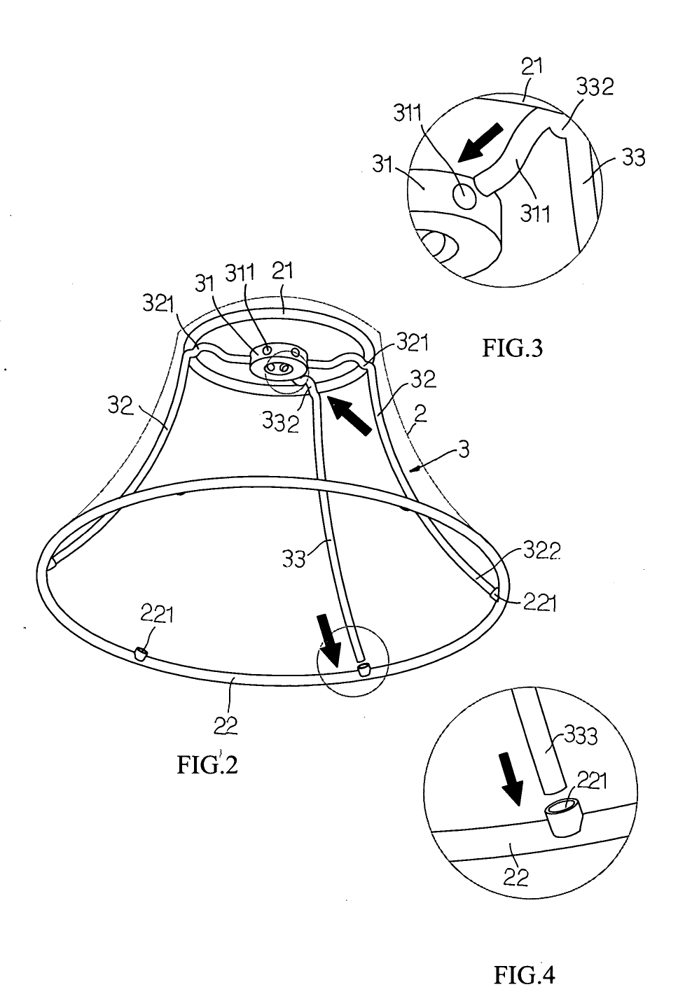

Then, each of the support bars 33 is mounted between the first ring 21 and the second ring 22, with the insert 331 being inserted into a respective one of the locking holes 311 of the support portion 31, the bent urging portion 332 being urged on the periphery of the first ring 21, and with the locking end 333 being locked in a respective one of the locking sockets 221 of the second ring 22, so as to fully expand and stretch the shade 2 as shown in FIG. 2.

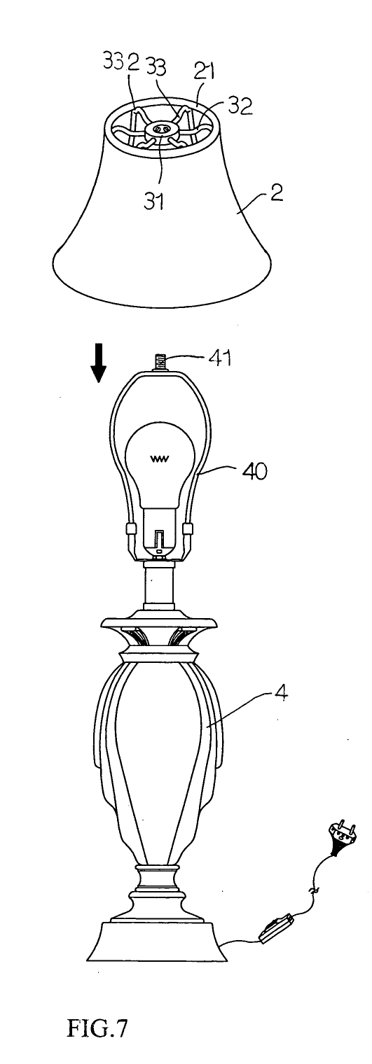

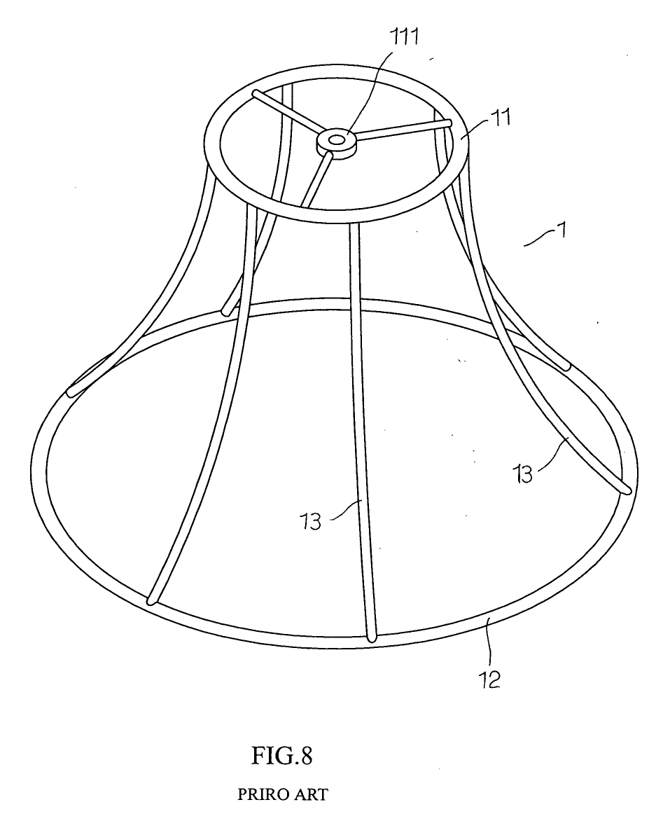

Subsequently, the expanded lamp shade is mounted on a table lamp 4 as shown in FIG. 7. The table lamp 4 includes a harp 40 mounted in the shade 2 and rested on the bottom of the support portion 31, a threaded rod 41 mounted on the harp 40 and extended through the support portion 31, and a decorative nut 42 screwed onto the threaded rod 41 and rested on the top of the support portion 31, so that the expanded lamp shade is mounted on the table lamp 4 as shown in FIG. 1.

Alternatively, the decorative nut 42 is unscrewed from the threaded rod 41 to detach the support portion 31 from the threaded rod 41 of the harp 40, so that the expanded lamp shade can be removed from the table lamp 4. Subsequently, the support bars 33 is detached from the support portion 31 and the second ring 22, and the main frame 32 is detached from the first ring 21 and the second ring 22, so as to fold the shade 2, thereby folding the lamp shade.

Accordingly, the lamp shade is assembled and disassembled easily and conveniently, thereby facilitating the user assembling and disassembling the lamp shade. In addition, the lamp shade can be fully folded when not in use, so as to reduce the volume of the lamp shade, thereby facilitating package, storage and transportation of the lamp shade, and thereby decreasing costs of package and transportation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp shade, comprising:
a shade;
a first ring fixed on a first end of the shade;
a second ring fixed on a second end of the shade; and
a support structure mounted in the shade and located between the first ring and the second ring for supporting the shade, wherein:
the support structure includes a main frame mounted between the first ring and the second ring to stretch the shade, and a support portion mounted on the main frame.

2. The lamp shade in accordance with claim 1, wherein the main frame is substantially inverted U-shaped.

3. The lamp shade in accordance with claim 1, wherein the main frame has a first portion formed with two bent urging portions each urged on a periphery of the first ring.

4. The lamp shade in accordance with claim 1, wherein the second ring has a periphery formed with a plurality of locking sockets, and the main frame has a second portion formed with two locking ends each locked in either one of the locking sockets of the second ring.

5. The lamp shade in accordance with claim 1, wherein the support structure further includes a plurality of support bars mounted between the first ring and the second ring.

6. The lamp shade in accordance with claim 5, wherein each of the support bars has a bent urging portion urged on a periphery of the first ring.

7. The lamp shade in accordance with claim 5, wherein the support portion has a periphery formed with a plurality of locking holes, and each of the support bars has a first end formed with an insert inserted into a respective one of the locking holes of the support portion.

8. The lamp shade in accordance with claim 5, wherein each of the support bars is substantially inverted L-shaped.

9. The lamp shade in accordance with claim 5, wherein the second ring has a periphery formed with a plurality of locking sockets, and each of the support bars has a second end formed with a locking end locked in a respective one of the locking sockets of the second ring.

10. The lamp shade in accordance with claim 1, wherein the support portion is ring-shaped and is mounted on the main frame by soldering.

11. The lamp shade in accordance with claim 1, wherein the support structure is foldable.

12. The lamp shade in accordance with claim 1, wherein the shade is made of flexible material.
